(19) United States
(12) Patent Application Publication
(10) Pub. No.: US 2023/0180806 A1
(43) Pub. Date: Jun. 15, 2023

(54) Delivery Composition, Methods of Manufacture and Use

(71) Applicants: Scott Knox, Miami, FL (US); Dennis Connors, Allen, TX (US); Paul J. Knox, Orlando, FL (US)

(72) Inventors: Scott Knox, Miami, FL (US); Dennis Connors, Allen, TX (US); Paul J. Knox, Orlando, FL (US)

(21) Appl. No.: 18/063,968

(22) Filed: Dec. 9, 2022

Related U.S. Application Data
(60) Provisional application No. 63/288,187, filed on Dec. 10, 2021.

(51) Int. Cl. A23L 29/212; A23L 33/175; A23L 27/30; A23L 33/15

(52) U.S. Cl. CPC A23L 29/212; A23L 33/175; A23L 27/30; A23L 33/15

(57) ABSTRACT

Compositions, methods of manufacturing the compositions, and methods of using the compositions are provided. In an embodiment the compositions utilize a delivery system which has a combination of monosaccharides and disaccharides to absorb the desired deliverables such as water. The individual components are mixed together, and ingested into a human body. Once in the human body, the deliverables that have been absorbed by the monosaccharides are moved into cells. The disaccharides are broken down into monosaccharides, and then the deliverables originally absorbed by the disaccharides are moved into the cells.

### PRIORITY CLAIM AND CROSS-REFERENCE

This application claims the benefit of U.S. Provisional Application No. 63/288,187, filed on Dec. 10, 2021, which application is hereby incorporated herein by reference.

### BACKGROUND

When the human body becomes dehydrated, the human body has trouble balancing water and other nutrients that are used to function properly. As such, when the body is dehydrated, it is desirable to rehydrate the body as fast as possible and then maintain the hydration. Methods and formulations for hydrating the human body have been increasingly developed over the past couple of years. As these formulations have been developed, new improvements are continually desired.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a first mixing process to form a composition, in accordance with some embodiments.

FIG. 2 illustrates a process of using the composition, in accordance with some embodiments.

FIG. 3 illustrates a second mixing process to form the composition, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, different deliverables and/or additives may be utilized in order to achieve different compositions and different flavors. In addition, the present disclosure may repeat reference numerals and/or letters in the various examples. This repetition is for the purpose of simplicity and clarity and does not in itself dictate a relationship between the various embodiments and/or configurations discussed.

In some embodiments a composition, method of manufacture, and method of use are provided in which the composition works to implement a faster delivery effect (hydration effect) in the human body and also allows for the faster delivery to extend for a longer period of time. The precise embodiments presented herein, however, are intended to be illustrative and are not intended to limit the ideas presented to only the embodiments discussed.

Looking now at one embodiment of the composition or formulation, the composition comprises a delivery system of one or more carbohydrates and one or more amino acids 105. Looking first at the one or more carbohydrates, the one or more carbohydrates may be a rice-based composition (e.g., DE10 or DE 18) comprising carbohydrates with a clean flavor profile, a zero sugar composition, and a low osmolality (wherein osmolality is a measure of the nutrients in the blood plasma and can be used to help determine how fast components can be absorbed), and may be a mixture of monosaccharides and disaccharides.

In an embodiment the one or more carbohydrates may comprise a primary carrier 101 (e.g., a carrier of deliverables 116 such as water 117 and electrolytes 109 (described further below)) and a secondary carrier 103 (e.g., of the deliverables 116 such as water 117 and electrolytes 109). In an embodiment the primary carrier 101 may be a carbohydrate such as rice maltodextrin DE10 or DE18, which is a zero sugar carbohydrate that comprises both monosaccharides and disaccharides. Per serving of the overall composition, the rice maltodextrin DE10 or DE18 may have a serving amount of between about 3700 mg/servings (or 53.9%-wt in a total composition serving of 6864.3 mg) and about 4570 mg/servings (or 66.57%-wt in a total composition serving of 6864.3 mg), such as about 3707 mg/serving (or 54%-wt in a total composition serving of 6864.3 mg). If the serving amount percent by weight is greater than this range, then there would be an increase in the amount of carbohydrates which could potentially slow down subsequent absorption in the body, while if the serving amount percent by weight is less than this range, then there would also be slower absorption.

The one or more carbohydrates may also comprise the secondary carrier 103. In an embodiment the secondary carrier 103 may be a carbohydrate such as apple cider vinegar powder, which has a zero sugar content and also has a lower carbohydrate content than the primary carrier 101 (e.g., the rice maltodextrin DE10 or DE18). In a particular embodiment, the apple cider vinegar powder may have a serving amount within the composition of between about 450 mg/servings (or 6.55%-wt in a total composition serving of 6864.3 mg) and about 550 mg/servings (or 8.01%-wt in a total composition serving of 6864.3 mg), such as about 500 mg/serving (or 7.28%-wt in a total composition serving of 6864.3 mg). If the serving amount is outside of this range, then there may be an undesired affect to the taste, such as the taste being too acidic.

Optionally, one or more amino acids 105 may be added to the delivery system in order to help speed the absorption and transportation of the desired deliverables 116 (e.g., the water 117 and the electrolytes 109) as well as to help slow fatigue. In particular embodiments, the amino acids 105 may also be used to improve muscle function. For example, in a particular embodiment the one or more amino acids 105 may comprise a mixture of three amino acids, such as L-Glycine, L-Alanine, L-Arginine Mono HCL, combinations of these, or the like.

In an embodiment a serving of the composition may comprise the amino acid L-Glycine at a serving amount of between about 200 mg/servings and about 220 mg/servings, such as about 200 mg/serving. The composition may further comprise the amino acid L-Alanine (e.g., to help slow fatigue) at a serving amount of between about 50 mg/servings and about 55 mg/servings, such as about 50 mg/serving. Finally, the composition may comprise the amino acid L-Arginine Mono HCL at a serving amount of between about 20 mg/servings and about 22 mg/servings, such as about 20 mg/serving. However, any suitable amino acids 105, any suitable number of amino acids 105, and any suitable amounts per serving may be utilized.

The delivery system comprising the primary carrier 101, the secondary carrier 103, and the one or more amino acids 105 provides multiple pathways for the composition to deliver a desired component (e.g., water) to the human body as described further below. For example, the monosaccharides within the primary carrier 101 and the secondary carrier 103 provide a first, fast pathway for the desired component (e.g., water) while the disaccharides within the primary carrier 101 and the secondary carrier 103 provide a second, slower and longer lasting pathway for the desired component.

Additionally, the delivery system can be utilized to deliver any suitable components to the human body. In one embodiment the delivery system may be utilized to deliver water and other components in order to help hydrate a human body, as described further below. In other embodiments, however, the delivery system may be used to provide any desired and suitable components to the human body.

Additionally, one or more vitamins 107 may be added to the delivery system in order to help the components of the delivery system be more efficient. In an embodiment the one or more vitamins 107 may be added in order to either help break down the one or more carbohydrates, other fats and sugars, and/or help maintain the health of nerves, skin, and cells within the body such as red blood cells. For example, in one embodiment a vitamin 107 such as vitamin B3 (niacin), may be added to the composition to help support the proper function of fats and sugars in the body and to maintain healthy cells, while a vitamin 107 such as vitamin B5 (as pantothenic acid) may be added to help break down fats. Additionally, vitamins 107 such as vitamin B6 (pyradoxine HCl) may be added in order to help maintain the health of nerves, skin and red blood cells, and a vitamin 107 such as riboflavin (5-Phosphate Sodium—a coenzyme form of vitamin B2) may be used to help break down fat and sugars. However, any suitable vitamins 107 and any suitable amounts per serving may be utilized.

In a particular embodiment the composition may comprise a mixture of vitamin B3, vitamin B5, vitamin B6, and riboflavin. The vitamin B3 may be at a serving amount of between about 22 mg/servings and about 25 mg/servings, such as about 22 mg/serving, and the vitamin B5 may be at a serving amount of between about 10 mg/servings and about 11 mg/servings, such as about 10 mg/serving. Additionally, the vitamin B6 may be at a serving amount of between about 2.3 mg/servings and about 2.5 mg/servings, such as about 2.3 mg/serving, and the vitamin riboflavin may be at a serving amount of between about 2 mg/servings and about 2.2 mg/servings, such as about 2 mg/serving. However, any suitable amounts may be utilized.

In some embodiments the delivery system comprising the primary carrier 101, the secondary carrier 103, and the one or more amino acids 105 may be utilized to deliver more than a single desired deliverable 116. For example, in an embodiment in which the delivery system delivers water to hydrate the human body, the delivery system may also be utilized to deliver one or more electrolytes 109. In an embodiment the one or more electrolytes 109 may be added to the composition in order to help regulate nerve and muscle function, hydrate the body, and balance blood acidity and pressure. In an embodiment the one or more electrolytes 109 may comprise electrolytes 109 such as calcium bisglycinate chelate, tripotasium citrate, combinations of these, or the like. However, any suitable electrolytes 109 may be used.

In a particular embodiment the one or more electrolytes 109 comprises a combination of calcium bisglycinate chelate and tripotasium citrate. In such an embodiment the calcium bisglycinate chelate within the composition may be at a serving amount of between about 75 mg/servings and about 84 mg/servings, such as 75 mg/serving, and the tripotasium citrate may be at a serving amount of between about 141 mg/servings and about 155 mg/servings, such as about 144 mg/serving. However, any suitable amounts may be used.

Other additives 111 may be added to the composition and the delivery system in order to assist with the overall functioning of the composition. For example, in an embodiment an amino acid chelate may be added in order to assist with the chemical reactions. In a particular embodiment the amino acid chelate may be a chelate such as magnesium bisglycinate chelate that helps to bind magnesium to the amino acids 105, such as glycine, and may be added to the composition to a serving amount of between about 270 mg/servings and about 292 mg/servings, such as about 270 mg/serving. However, any suitable amino acid chelate and any suitable amounts may be used.

Another additive 111 may be a pH control additive which is used to help control the pH of the eventual solution derived from the composition. In an embodiment the pH control additive may be an additive 111 such as trisodium citrate dihydrate, and may be added to a serving amount of between about 374 mg/servings and about 411 mg/servings, such as about 374 mg/serving. However, any suitable pH control additive 111 and any suitable amount may be used.

In particular embodiments in which the delivery system is utilized to delivery water, additives 111 for taste may also be added to modify the taste of the composition. In an embodiment the additives 111 for taste may comprise additives 111 such as organic stevia RA 99% (ProSweetz), natural lemon lime flavor (e.g., WONF (Zoom Essence) ZE41288), sea salt (which may comprise other minerals such as magnesium, calcium and potassium), organic monk fruit, citric acid, combinations of these, or the like. In a particular embodiment which utilizes each of the organic stevia RA 99% (ProSweetz), the natural lemon lime flavor, the sea salt, the organic monk fruit, and the citric acid, the organic stevia RA 99% (ProSweetz) may be added to the composition at a serving amount of between about 90 mg/servings and about 99 mg/servings, such as about 90 mg/serving, the natural lemon lime flavor may be added at a serving amount of between about 300 mg/servings and about 330 mg/servings, such as about 300 mg/serving, the sea salt may be added at a serving amount of between about 800 mg/servings and about 880 mg/servings, such as about 800 mg/serving, the optional organic monk fruit may be added at a serving amount of between about 8 mg/servings and about 8.8 mg/servings, such as about 8 mg/servings, and the citric acid may be added at a serving amount of between about 300 mg/servings and 330 mg/servings, such as 300 mg/serving. However, any suitable additives 111 and any suitable amounts may be utilized.

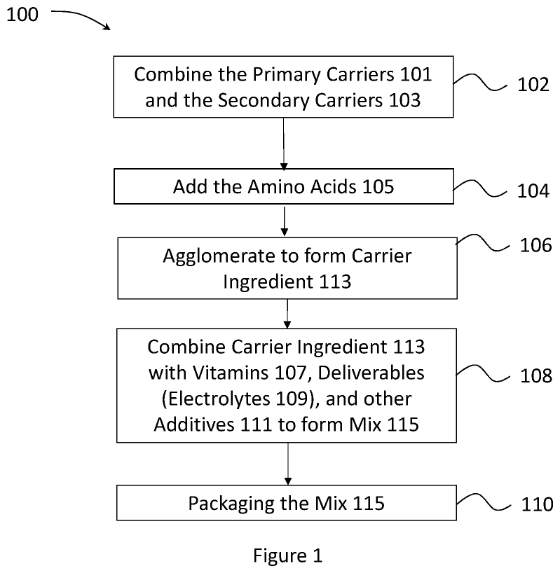

FIG. 1 illustrates a first mixing process 100 to prepare individual servings of the above described composition in an embodiment to deliver water. To prepare the composition in a powder form, one or more of the primary carriers 101 (e.g., the rice maltodextrin DE10 or DE18) and one or more of the secondary carriers 103 (e.g., the apple cider vinegar powder) are mixed together in a first step 102 to form the delivery system. In an embodiment the mixing is performed in commercial, state of the art equipment that works to make a uniform powder mix. However, any suitable mixing process or equipment may be utilized.

Once the one or more primary carriers 101 and the one or more secondary carriers 103 have been mixed together, the optional amino acids 105 (e.g., glycine, alanine, and arginine) may be added in a second step 104. In an embodiment the mixing may be performed in the same commercial, state of the art equipment that was utilized to mix the one or more primary carriers 101 and the one or more secondary carriers 103. However, in other embodiments a different mixing system may be used.

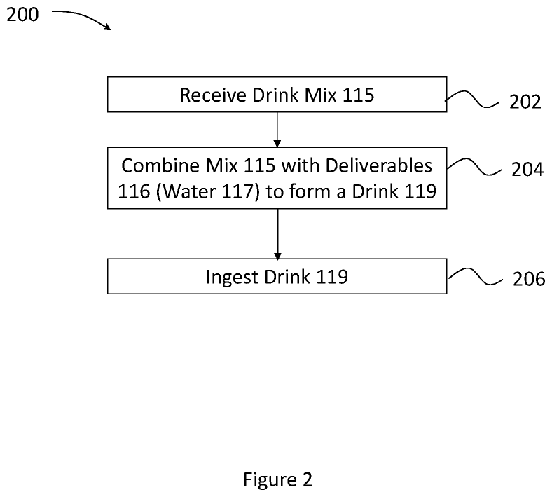

Once mixed, the mixture is then agglomerated in order to improve the delivery system's bulk density, flowability, dispersibility, and stability in a third step 106. For example, the agglomeration may be performed such that the powder particles are bound together to create a larger particle that will easily mix into a solution (described further below with respect to FIG. 2). In an embodiment the agglomeration may be performed using a fluid bed processor to unite the various properties into one consistent powder to enhance performance for the consumer. By spraying in a fluidized bed system, the individual powdery, non-flowing and often poorly soluble particles are converted into a free-flowing agglomerate with outstanding solubility. The method is particularly suitable as a preliminary step for superior instantized drinking powders that have little floating particulate or bottom sediment for maximum consumer benefit of the active nutrients.

In particular, the spray agglomeration moves very small, powder particles in the fluidized bed where they are sprayed with a binder solution or suspension. Liquid bridges are created that form agglomerates from the particles. Spraying continues until the desired size of the agglomerates is reached. After the residual moisture in the capillaries and on the surface has evaporated, hollow spaces are created in the granulate while the new structure is solidified throughout by the hardened binder. The lack of kinetic energy in the fluidized bed results in very porous structures with plenty of internal capillaries. Because of this porous character and large surface structure, the resulting agglomerated powder is very soluble when subsequently introduced to liquid.

Once the agglomeration is performed, the resultant powder of the delivery system may be considered a carrier ingredient 113 and is ready for additional elements. In one embodiment in which water 117 is used as the desired deliverable 116, the vitamins 107 (e.g., B2, B3, B5 and/or B6, as described above), the electrolytes 109 (e.g., sodium, potassium, magnesium and/or calcium), the sweetener additives 111 (e.g., organic stevia and/or monk fruit), and the natural flavoring additives 111 are then blended in with the carrier ingredient 113 in a fourth step 108 to create a free flowing, quickly dissolvable mix 115. Such a mix 115 may be a combination of all of the individual ingredients.

In an embodiment in which the mix 115 is desired to be used to deliver water, once the mix 115 has been formed, the mix 115 may then be packaged, stored, transported, and/or distributed to the end user in a fifth step 110. In a particular embodiment the packaging may include placing individual servings into individual packages, such as stick packages, or else may be placed in bulk containers (for, e.g., shipment) prior to placement within individual packages. If shipped in bulk, the bulk quantities may be shipped locally or overseas, where local packaging or combinations with local, more specific water types might be desirable. In a particular embodiment each individual serving may have a total mass of about 6864.3 mg/serving, or 6.8643 g/serving, although any suitable serving size may be utilized.

Of course, while a specific process for mixing and preparing the mix 115 has been presented above, this description is intended to be illustrative only and is not intended to limit the embodiments to the precise steps and the precise order described. Rather, any suitable order of mixing steps and methods may be utilized, such as mixing the one or more primary carriers 101, the one or more secondary carriers 103, and the amino acids 105 at the same time. All such steps and orders are fully intended to be included within the scope of the embodiments.

FIG. 2 illustrates a first use process 200 that an end user performs upon purchasing or otherwise receiving the packaged mix 115 in a first use step 202 for an embodiment which delivers water to hydrate the human body. In particular, once the end user is ready to use the mix 115, the mix 115 may be added to one or more solvents, such as water 117, in a second use step 204. In a particular embodiment in which the mix 115 comprises a total of 6864.3 mg/serving of ingredients, the mix 115 may be added to 16 oz. of water 117 to form a drink 119. However, any suitable solvent and any suitable amount may be utilized.

By manufacturing the composition as described above with the delivery system (e.g., the primary carriers 101, the secondary carriers 103, and the amino acids 105) and then mixing it with, e.g., the water 117, a high tonicity (e.g., a measure of osmolality in a beverage), hypotonic drink 119 may be achieved (instead of lower tonicity drinks such as isotonic drinks which have a large sugar content), wherein the hypotonic drink 119 has zero sugar, is non-GMO, gluten free, vegan, and all natural. For example, the hypotonic drink 119 may have an osmolality level of less than about 275 mOsm/kg water, and has a lower concentration of fluid, sugars and salt than blood. Such a low osmolality helps, once ingested, to move solutions via osmosis across the gut walls and into the blood vessels, meaning a fast delivery occurs as the drink 119 is rapidly absorbed across the gut lining. In particular, by having a high tonicity, the ability of an extracellular solution to move deliverables 116 such as the water 117 into or out of the cells of the human body by osmosis is also high.

Such decreases in osmolality is in direct contradiction to other types of systems such as isotonic drinks and hypertonic drinks. For example, isotonic drinks may have an osmolality ranging from about 275 to about 330 mOsm/kg water, and has a similar concentration of fluid, sugars, and salt than blood, leading to a slower absorption than hypotonic drinks. Finally, hypertonic drinks may have an osmolality between about 492 mOsm/kg water and about 784 mOsm/kg water, and has a higher concentration of fluids, sugars and salt than blood (e.g., juices, nectars, energizing drinks, and colas), leading to a slow absorption relative to the composition described herein.

Additionally, when the composition is introduced to the water 117, a number of processes begin with regards to the individual components. In an embodiment the primary carriers 101 and the secondary carriers 103 will both begin to absorb the water 117 and the electrolytes 109. For example, the monosaccharides in the mix 115 will begin to physically absorb the water 117 and the electrolytes 109. Further, the disaccharides in the mix 115 will also begin to physically absorb the water 117 and the electrolytes 109 as well.

Once the drink 119 is ready, the drink 119 may be ingested by any suitable method, such as drinking, in a third use step 206. Once in the body, the monosaccharides make their way through the body and towards individual cells, where they immediately enter the cells. Additionally, as the monosaccharides enter the cells, the deliverables 116 that are absorbed by the monosaccharides (e.g., the water 117 and the electrolytes 109 in embodiments where the deliverable 116 is water) will also enter the cells, thereby bringing the desired deliverables 116 (e.g., the absorbed water 117 and the electrolytes 109) into the cell with it at a fast rate, thereby providing an immediate delivery (e.g., hydration) to those cells.

However, the disaccharides present within the drink 119 are not able to immediately enter the cell as easily as the monosaccharides. Rather, the body (with, e.g., the help of the vitamin B complexes), will begin to chemically break down the disaccharides into monosaccharides. Once the disaccharides have been broken down into the newly formed monosaccharides, the newly formed monosaccharides are now able to enter the cells, thereby carrying the desired deliverables 116 (e.g., the water 117 and the electrolytes 109) that were originally absorbed by the disaccharides into the cells.

However, because of the time it takes for the disaccharides to be broken down into the monosaccharides, the deliverables 116 that had been originally absorbed by the disaccharides are delayed from entering the cell. As such, the deliverables 116 originally absorbed by the monosaccharides enter the cells first (thereby providing for an immediate delivery), while the deliverables 116 originally absorbed by the disaccharides are delayed from immediately entering the cells.

As such, by providing multiple paths for the deliverables 116 to enter the cells, a longer, more time-released process can be utilized while still providing the benefits of an immediate, faster delivery process. In particular, in an embodiment to deliver water, by delaying a portion of the water 117 until the disaccharides are broken down into monosaccharides, the portion of the water 117 and the electrolytes 109 originally absorbed by the disaccharides are used to hydrate cells at a later time. As such, the overall hydration process can be continued for a longer time.

By utilizing the embodiments described herein as a hydration delivery system, a composition may be achieved that offers a fast absorption rate and replenishes not just electrolytes 109 but also other nutrients that are lost from dehydration. As such, the drink 119 can help modify the osmolality of the body (e.g., a measure of the water and nutrients in the blood plasma of the body), so that the body is well hydrated, e.g., to an osmolality level of between about 275 mOsmol/Kg and about 290 mOsmol/Kg.

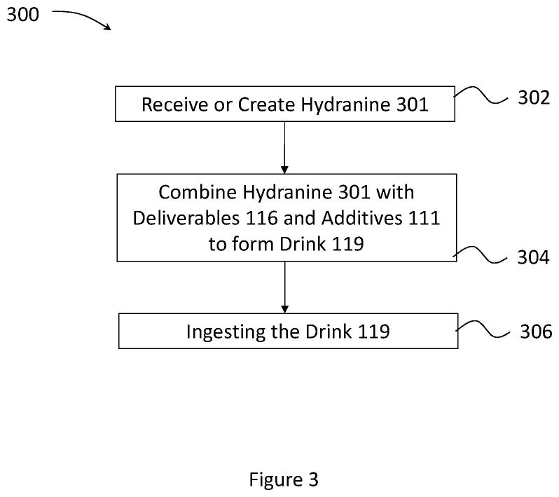

FIG. 3 illustrates a mixing and ingestion process 300 that may be used to help form the mix 115 and deliver the deliverables to the human body. In this embodiment the composition may be manufactured by initially receiving or creating the delivery system (e.g., the primary carrier 101, the secondary carrier 103, and the one or more amino acids 105) as an initial agglomerated powder in a first mixing and ingestion step 302. In a particular embodiment the initial agglomerated powder may be a mixture such as Hydranine 301, which may be a mixture of the rice maltodextrin, the apple cider vinegar powder, the L-Glycine, the L-Alanine, and the L-Arginine mono HCl) as described above. However, any suitable delivery system may be utilized.

Once the delivery system is ready, the desired deliverables 116 and other additives may be added to the delivery system in a second mixing and ingestion step 304 as described above with respect to FIG. 1. For example, in an embodiment in which one of the deliverables 116 is water 117 and other additives are desired (as described above) the additives such as the trisodium citrate dihydrate, magnesium bisglycinate chelate, sea salt, tripotasium citrate, vitamin B5 (as pantothenic acid), calcium bisglycinate chelate, vitamin B3 niacin, organic monk fruit, vitamin B6 pyradoxine HCL, riboflavin 5-phosphate sodium, natural lemon lime flavor, and the organic stevia RA 99% (ProSweetz) may be added, and then the composition may be, packaged, shipped and added to the water 117 as one of the deliverables 116.

In a particular embodiment in which the delivery system is utilized to deliver the water 117, the Hydranine 301 may be present in a range of between about 4420 mg/serving and about 5417 mg/serving, such as about 4470 mg/serving. Additionally, in a very particular embodiment the final composition may have a Hydranine 301 percentage of about 65.12%-weight (4470 mg/serving divided by 6864.3 mg/serving), the trisodium citrate dihydrate may have a percentage of about 5.45%-weight (374 mg/serving divided by 6864.3 mg/serving), the magnesium bisglycinate chelate may have a percentage of about 3.93%-weight (270 mg/serving divided by 6864.3 mg/serving), the sea salt may have a percentage of about 11.65%-weight (800 mg/serving divided by 6864.3 mg/serving), the tripotasium citrate may have a percentage of about 2.05%-weight (141 mg/serving divided by 6864.3 mg/serving), the vitamin B5 (as pantothenic acid) may have a percentage of about 0.15%-weight (10 mg/serving divided by 6864.3 mg/serving), the calcium bisglycinate chelate may have a percentage of about 1.09%-weight (75 mg/serving divided by 6864.3 mg/serving), the vitamin B3 niacin may have a percentage of about 0.32%-weight (22 mg/serving divided by 6864.3 mg/serving), the organic monk fruit may have a percentage of about 0.12%-weight (8 mg/serving divided by 6864.3 mg/serving), the vitamin B6 pyradoxine HCL may have a percentage of about 0.03%-weight (2.3 mg/serving divided by 6864.3 mg/serving), the riboflavin 5-phosphate sodium may have a percentage of about 0.03%-weight (2 mg/serving divided by 6864.3 mg/serving), the natural lemon lime flavor may have a percentage of about 4.37%-weight (300 mg/serving divided by 6864.3 mg/serving), the organic stevia RA 99% (ProSweetz) may have a percentage of about 1.31%-weight (90 mg/serving divided by 6864.3 mg/serving), and the citric acid may be have percentage of about 4.37%-weight (300 mg/serving divided by 6864.3 mg/serving). However, any suitable percentages may be utilized. The composition in this embodiment, once mixed together, may have a total of about 6864.3 mg/serving.

Once the components have been mixed and the drink 119, the drink 119 can be introduced to the human body in a third mixing and ingestion step 306. In an embodiment the introduction may be performed through, e.g., ingesting or drinking the drink 119. However, any suitable method of introducing the drink 119 to the human body may be utilized. Once in the body, the drink 119 will provide the faster and longer hydration as described above.

Of course, while a specific embodiment in which the delivery system is utilized to deliver water and other deliverables is described above, this is intended to be illustrative and is not intended to limit the embodiments to a hydration delivery system. Rather, the delivery system described could be used to deliver a wide variety of deliverables. For example, in another embodiment, the delivery system may be utilized to deliver a beauty product such as collagen to the cells of the human body. In still other embodiments, the delivery system may be utilized to deliver drugs to the human body. All such embodiments may be utilized, and all such embodiments are fully intended to be included within the scope of the embodiments.

In an embodiment, a delivery composition includes: a primary carrier comprising rice maltodextrin; and a secondary carrier comprising apple cider vinegar powder. In an embodiment, the delivery composition further includes one or more amino acids. In an embodiment, the one or more amino acids includes three amino acids. In an embodiment, the three amino acids include L-Glycine, L-Alanine, and L-Arginine Mono HCL. In an embodiment the primary carrier has a concentration of between about 3700 mg/serving and about 4570 mg/serving. In an embodiment the secondary carrier has a concentration of between about 450 mg/serving and about 550 mg/serving.

In another embodiment, a method includes: mixing a primary carrier, a secondary carrier, and one or more amino acids together to form a first mixture, the primary carrier comprising rice maltodextrin and the secondary carrier comprising apple cider vinegar powder; agglomerating the first mixture to form a first carrier mixture; and adding a deliverable to the first carrier mixture. In an embodiment the one or more amino acids is three amino acids. In an embodiment the three amino acids are L-Glycine, L-Alanine, and L-Arginine Mono HCL. In an embodiment after the adding the deliverable the L-Glycine is present at a serving amount of between about 200 mg/servings and about 220 mg/servings, the L-Alanine is present at a serving amount of between about 50 mg/servings and about 55 mg/servings, and the L-Arginine Mono HCL is present at a serving amount of between about 20 mg/servings and about 22 mg/servings. In an embodiment the adding the deliverable adds water. In an embodiment the adding the deliverable additionally adds electrolytes. In an embodiment after the adding the deliverable the rice maltodextrin has a concentration of between about 3700 mg/serving and about 4570 mg/serving. In an embodiment after the adding the deliverable the apple cider vinegar powder has a concentration of between about 450 mg/serving and about 550 mg/serving.

In yet another embodiment, a method includes: forming a first mixture, the first mixture comprising rice maltodextrin, apple cider vinegar powder, and amino acids; agglomerating the first mixture into a first carrier mixture; adding calcium bisglycinate, magnesium bisglycinate chelate, trisodium citrate dihydrate, tripotasium citrate, sea salt, vitamin B3, vitamin B5, vitamin B6, and riboflavin to form a prepared mixture; and forming individual servings from the prepared mixture. In an embodiment the method further includes adding organic stevia. In an embodiment the rice maltodextrin is present in the individual servings at a concentration of between about 3700 mg/servings and about 4570 mg/servings. In an embodiment the apple cider vinegar powder is present in the individual servings at a concentration of between about 450 mg/servings and about 550 mg/servings. In an embodiment the calcium bisglycinate is present in the individual servings at a concentration of between about 75 mg/servings and about 84 mg/servings, the magnesium bisglycinate chelate is present in the individual servings at a concentration of between about 270 mg/servings and about 292 mg/servings, the trisodium citrate dihydrate is present in the individual servings at a concentration of between about 374 mg/servings and about 411 mg/servings, and the tripotasium citrate is present in the individual servings at a concentration of between about 141 mg/servings and about 155 mg/servings. In an embodiment the vitamin B3 is present in the individual servings at a concentration of between about 22 mg/servings and about 25 mg/servings, the vitamin B6 is present in the individual servings at a concentration of between about 2.3 mg/servings and about 2.5 mg/servings, and the riboflavin is present in the individual servings at a concentration of between about 2 mg/servings and about 2.2 mg/servings.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A delivery composition comprising:
a primary carrier comprising rice maltodextrin; and
a secondary carrier comprising apple cider vinegar powder.

2. The delivery composition of claim 1, further comprising one or more amino acids.

3. The delivery composition of claim 2, wherein the one or more amino acids comprises three amino acids.

4. The delivery composition of claim 3, wherein the three amino acids comprise L-Glycine, L-Alanine, and L-Arginine Mono HCL.

5. The delivery composition of claim 1, wherein the primary carrier has a concentration of between about 3700 mg/serving and about 4570 mg/serving.

6. The delivery composition of claim 5, wherein the secondary carrier has a concentration of between about 450 mg/serving and about 550 mg/serving.

7. A method comprising:
mixing a primary carrier, a secondary carrier, and one or more amino acids together to form a first mixture, the primary carrier comprising rice maltodextrin and the secondary carrier comprising apple cider vinegar powder;
agglomerating the first mixture to form a first carrier mixture; and
adding a deliverable to the first carrier mixture.

8. The method of claim 7, wherein the one or more amino acids is three amino acids.

9. The method of claim 8, wherein the three amino acids are L-Glycine, L-Alanine, and L-Arginine Mono HCL.

10. The method of claim 9, wherein after the adding the deliverable the L-Glycine is present at a serving amount of between about 200 mg/servings and about 220 mg/servings, the L-Alanine is present at a serving amount of between about 50 mg/servings and about 55 mg/servings, and the L-Arginine Mono HCL is present at a serving amount of between about 20 mg/servings and about 22 mg/servings.

11. The method of claim 7, wherein the adding the deliverable adds water.

12. The method of claim 11, wherein the adding the deliverable additionally adds electrolytes.

13. The method of claim 7, wherein after the adding the deliverable the rice maltodextrin has a concentration of between about 3700 mg/serving and about 4570 mg/serving.

14. The method of claim 7, wherein after the adding the deliverable the apple cider vinegar powder has a concentration of between about 450 mg/serving and about 550 mg/serving.

15. A method comprising:
forming a first mixture, the first mixture comprising rice maltodextrin, apple cider vinegar powder, and amino acids;
agglomerating the first mixture into a first carrier mixture;
adding calcium bisglycinate, magnesium bisglycinate chelate, trisodium citrate dihydrate, tripotasium citrate, sea salt, vitamin B3, vitamin B5, vitamin B6, and riboflavin to form a prepared mixture; and
forming individual servings from the prepared mixture.

16. The method of claim 15, further comprising adding organic stevia.

17. The method of claim 16, wherein the rice maltodextrin is present in the individual servings at a concentration of between about 3700 mg/servings and about 4570 mg/servings.

18. The method of claim 17, wherein the apple cider vinegar powder is present in the individual servings at a concentration of between about 450 mg/servings and about 550 mg/servings.

19. The method of claim 18, wherein the calcium bisglycinate is present in the individual servings at a concentration of between about 75 mg/servings and about 84 mg/servings, the magnesium bisglycinate chelate is present in the individual servings at a concentration of between about 270 mg/servings and about 292 mg/servings, the trisodium citrate dihydrate is present in the individual servings at a concentration of between about 374 mg/servings and about 411 mg/servings, and the tripotasium citrate is present in the individual servings at a concentration of between about 141 mg/servings and about 155 mg/servings.

20. The method of claim 19, wherein the vitamin B3 is present in the individual servings at a concentration of between about 22 mg/servings and about 25 mg/servings, the vitamin B6 is present in the individual servings at a concentration of between about 2.3 mg/servings and about 2.5 mg/servings, and the riboflavin is present in the individual servings at a concentration of between about 2 mg/servings and about 2.2 mg/servings.
